(19) United States
(12) Patent Application Publication
(10) Pub. No.: US 2018/0098181 A1
(43) Pub. Date: Apr. 5, 2018

(54) METHODS AND SYSTEMS FOR IMPLEMENTING APPLICATION CHAINING AND FOR DISPLAYING CUSTOMIZED CONTENT IN A WELCOME SCREEN

(71) Applicant: SONIFI Solutions, Inc., Sioux Falls, SD (US)

(72) Inventors: Derin Michael Zerr, Kahului, HI (US); Shaun Eugene Marko, Oak Park, IL (US); Daniel A. Dirks, Vancouver, WA (US); Joel Walter Zdepski, Mountain View, CA (US)

(21) Appl. No.: 15/720,557

(22) Filed: Sep. 29, 2017

Related U.S. Application Data
(60) Provisional application No. 62/402,762, filed on Sep. 30, 2016.
(60) Provisional application No. 62/452,165, filed on Jan. 30, 2017.

(51) Int. Cl. H04W 4/00; H04W 4/02; H04W 76/02; H04W 88/00; H04L 29/08

(52) U.S. Cl. CPC H04W 4/005; H04W 4/02; H04L 67/14; H04W 88/005; H04W 76/02

(57) ABSTRACT

Systems and methods directed to a communication system in a hospitality environment are provided. The communication system may include a server, an output device, and a local player in communication with the server and configured to provide display information to the output device. The local player is configured to provide a status message to the server, receive application identification from the server identifying one or more applications to execute, retrieve additional content from a content source, and execute the one or more applications thereby providing the display information including the additional content to the output device for display at the output device.

### RELATED APPLICATIONS

This application claims the benefit of U.S. Provisional Patent Application Ser. No. 62/402,762, filed Sep. 30, 2016, and U.S. Provisional Patent Application Ser. No. 62/452,165, filed Jan. 30, 2017, the entire disclosures of which are hereby incorporated herein by reference in their entirety. This application is related to U.S. Provisional Patent Application Ser. No. 62/308,442, filed Mar. 15, 2016, the entire disclosures of which are hereby incorporated herein by reference in their entirety.

### FIELD

Systems and methods for displaying customized content and further executing a series of applications on output devices are disclosed.

### BACKGROUND

Increasingly, video entertainment, such as movies and television shows, is delivered to users on demand over digital networks. In addition, the distribution of content has expanded to include user devices, such as smart phones. These user devices have the ability to interface with content delivery systems and to output video and other content to users and various output devices. However, because of the need for mobility, the output capabilities of user devices are necessarily limited. Therefore, it is desirable to direct content streams associated with a user device to televisions or home theater systems.

Systems and methods currently available include those that involve establishing a dedicated connection between a user device and an output device. However, such dedicated connections can be limited by controls put in place by digital rights management systems in addition to processor and memory utilization of the user device. Moreover, the user device, and thus the user, control the content delivered to such output devices. In some environments, such as hospitality settings, the user may control what content is displayed and when it is to be displayed and therefore limit control of the hospitality provider.

Further, in many hospitality settings, there is a desire to provide entertainment services to guests using applications and devices that are familiar to guests. Accordingly, making such entertainment services, such as Netflix®, available to guests while maintaining security and implementing device isolation, which prevents user devices from discovering other devices, has proved to be difficult. For example, Wi-Fi clients may be restricted from seeing other Wi-Fi devices. A requirement of device isolation thus conflicts with the desire to allow a user device to discover and make use of other Wi-Fi devices in the vicinity of the user device and further allow a user to use video entertainment applications familiar to the user. Moreover, when not in use by a user device, output devices generally sit idle and provide little functionality even though such output devices exist as part of a network and are otherwise accessible.

### SUMMARY

Embodiments of the present disclosure are directed to systems and methods for providing entertainment services to users using applications and devices that are familiar to guests while customizing and expanding functionality of such devices. Further, embodiments of the present disclosure may be directed to delivering customized content to the output devices when such output devices are not in use by other user devices. Embodiments of the present disclosure enable a user device to operably connect to an output device through a selected local player, such as an over-the-top (OTT) device. In accordance with at least some embodiments of the present disclosure, a local player includes an app, or application, that is operable to display customized content at the direction of a user device and generally after being paired or otherwise associated with the user device. For example, the app may be operable to request a pairing code from a network authority. The pairing code obtained by the local player can be displayed on an output device connected to the local player. A user can then enter the displayed pairing code into the user device, and send that code to a verification and/or authorization server using an app.

In a hospitality setting, for a user device to send content, or cast content, to an output device, a user's device must be registered with a system network controller (SNC). Once the registration is complete, the user's device is paired with their current room and casting may be enabled for any television in that room for compatible applications. The registration and pairing require certain pieces of information to be transmitted to the SNC server. The SNC server gets this information transmitted to it via web service calls/APIs from different external sources depending on registration method and site configuration. The SNC server maintains the pairing association between a user's device, room, and local players (e.g., Chromecast devices or “over-the-top” (OTT) devices) in that room until instructed to destroy that association. The SNC server may require identification information, such as a room number and/or IP and/or MAC address of the user's device in order to register that device and pair it with the user's (e.g., the guest's) room. The SNC server, once paired, forwards the correct network traffic between a user's device and the local player in the guest room, allowing casting of content to the local player. The SNC server may maintain a table of local players in each room and create a lookup table of device MAC addresses paired with local players in each room at any given time. All web service calls to or from the SNC server may contain basic information such as date, time, a sequence/packet identifier, etc.

In accordance with embodiments of the present disclosure, when an output device is not in use, for example when the OTT device is not being used in connection with an output device to display content at the output device, the SNC may cause the OTT device to send customized content to be displayed at the output device; such customized content may be in the form of a default or welcome screen. The default or welcome screen may display user (guest) related information, where such information is obtained from various information sources. For example, the default or welcome screen may include specific operator branding information, such as a logo, and may further include information about a guest's schedule, conference schedule, guest experience, and/or local information for example.

In accordance with embodiments of the present disclosure, when an OTT device is being used in connection with an output device to display content at the output device, the OTT device may launch a series, or chain, of other apps. Such series, or chain, of apps may be determined based on a current app that is running, user information, user location, hospitality requirements, and/or at random. As one non-limiting example, an app may be running which is generally associated with a checkout process. At the conclusion of the checkout process, the OTT device may execute one or more apps requesting guest or user feedback and/or comments.

In accordance with embodiments of the present disclosure, a communication system in a hospitality environment may include a server, an output device, and a local player in communication with the server. The local player may be configured to provide display information to the output device and further provide a status message to the server. The local player may be configured to receive application identification from the server identifying one or more applications to execute, retrieve additional content from a content source, and execute the one or more applications thereby providing the display information including the additional content to the output device for display at the output device. In accordance with one or more aspects of the above embodiment, the status message may indicate that the local player is in an inactive state. In accordance with one or more aspects of the above embodiment, the status message may indicate an amount of time that the local player has been inactive. In accordance with one or more aspects of the above embodiment, the additional content may be guest-related information including at least one guest name. In accordance with one or more aspects of the above embodiment, the communication system may include a first network connecting the server to the local player and a second network connecting the local player to the content source. In accordance one or more with aspects of the above embodiment, the content source may be physically located at a site other than a site at which the local player is physically located. In accordance with one or more aspects of the above embodiment, the additional content may include location information related to a location in which the local player is located.

In accordance with embodiments of the present disclosure, a method for displaying content at an output device is provided. The method includes providing, by a local player connected to the output device, a status message to a system network controller indicating that the local player is inactive, receiving, at the local player, application identification information, the application identification information identifying one or more applications to launch, retrieving additional content from a content source, assembling display information that includes the additional content received from the content source, and providing the assembled display information to the output device. In accordance with one or more aspects of the above embodiment, the status message may indicate that the local player is in an inactive state. In accordance with one or more aspects of the above embodiment, the status message may indicate an amount of time that the local player has been inactive. In accordance with one or more aspects of the above embodiment, the additional content may be guest-related information including at least one guest name. In accordance with one or more aspects of the above embodiment, the method may include retrieving location information related to a location in which the local player is located, where the assembled display information includes the guest-related information and the location information.

In accordance with embodiments of the present disclosure, a method for chaining two or more applications together is provided. The method may include receiving, at a local player, first application identification information, the first application identification information identifying a first application to launch, launching the first application, after launching the first application, determining that a second application is to be launched, receiving, at the local player, the second application identification information, the second application identification information identifying the second application to launch, and launching the second application. In accordance with one or more aspects of the above embodiment, the method may further include adding the second application identification information to an application list. In accordance with one or more aspects of the above embodiment, the method may further include removing third application identification information identifying a third application from the application list. In accordance with one or more aspects of the above embodiment, the application list may include application identification information for a plurality of applications. In accordance with one or more aspects of the above embodiment, the application list may be received from a system network controller. In accordance with one or more aspects of the above embodiment, the second application identification information may be added to the application list at a device other than the local player. In accordance with one or more aspects of the above embodiment, the method may further include determining that a second application is to be launched prior to the first application completing execution. In accordance with one or more aspects of the above embodiment, the method may further include providing a notification to a device other than the local player that the first application has completed execution.

Additional features and advantages of embodiments of the present disclosure will become more readily apparent from the following description, particularly when taken together with the accompanying drawings.

### BRIEF DESCRIPTION OF THE DRAWINGS

FIG. 1 is a block diagram depicting components of a system in accordance with embodiments of the present disclosure;

FIG. 2 is a block diagram depicting components of a second system in accordance with embodiments of the present disclosure;

FIG. 3 depicts a display of customized content in accordance with embodiments of the present disclosure;

FIG. 4 depicts a process for selecting and delivering content in response to an idle condition in accordance with embodiments of the present disclosure;

FIGS. 5A-5B depict processes for chaining multiple applications in accordance with embodiments of the present disclosure;

FIG. 6 depicts components of an application in accordance with embodiments of the present disclosure;

FIG. 7 depicts aspects of a system network controller (SNC) in accordance with embodiments of the present disclosure;

FIG. 8 depicts aspects of an over-the-top device (OTT) in accordance with embodiments of the present disclosure;

FIG. 9 depicts a first application chain in accordance with embodiments of the present disclosure;

FIG. 10 depicts a second application chain in accordance with embodiments of the present disclosure;

FIG. 11 depicts a third application chain in accordance with embodiments of the present disclosure; and

FIGS. 12A-12C depict a series of displays that may be presented to an output device in accordance with embodiments of the present disclosure.

### DETAILED DESCRIPTION

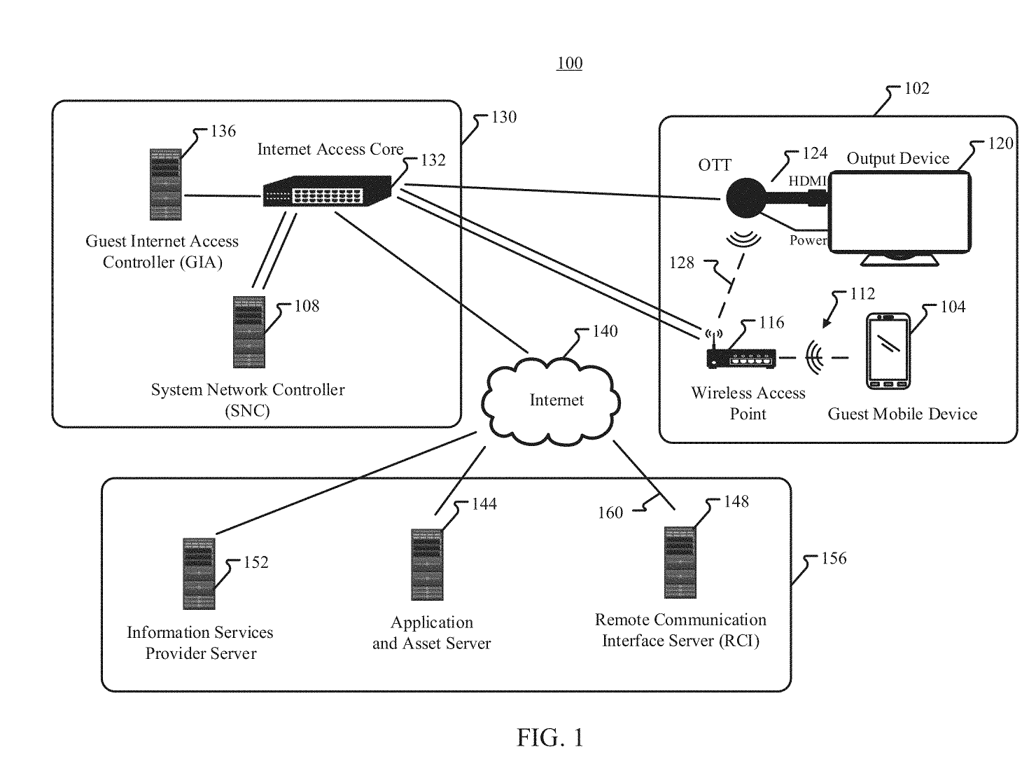

FIG. 1 is a block diagram illustrating a system 100 for enabling connectivity in accordance with embodiments of the present disclosure. The system 100 generally includes one or more user devices 104. As an example, but without limitation, a user device 104 may comprise a mobile device, such as a smart phone. As further examples, a user device 104 may comprise a tablet or a laptop computer. A user device 104 can connect to a system network controller (SNC) 108 through a first or guest communication network 112. As an example, but without limitation, the first communication network 112 may comprise a Wi-Fi network provided through one or more access points 116. For instance, an access point 116 may be provided for a particular and/or specific guest room 102 or group of guest rooms. Access to the first communication network 112 by user device 104 can require entry of a valid room number, guest name, or other credential.

The system 100 also includes one or more output devices 120, for example televisions, each of which may be associated with a local player 124, such as a Chromecast device. The local player 124 can be connected to the output device 120 via an HDMI port. Power may be supplied to the local player 124 through a USB port associated with the output device 120. The USB port may be one that supplies power when the output device 120 is itself powered on, or can be configured to supply power continuously. In accordance with other embodiments, power may be supplied to the local player 124 through other means. For example, the local player 124 can be connected to a wall outlet. Alternatively, or in addition, the local player 124 may reside within the output device 120. That is, the output device 120 may include the functionality of the local player 124. In accordance with embodiments of the present disclosure, the local player 124 may be connected to the SNC 108 through a second, communication network 128 which may be hidden. The second communication network 128 may be provided by the same or a different access point 116 as is used to provide the first communication network 112.

The SNC 108 may perform registration functions with respect to devices, including but not limited to, mobile devices 104, output devices 120, and local players 124. More specifically, the SNC 108 may maintain a table of information identifying such devices 104, 120 and 124, and associations between such devices. Moreover, upon the completion of registration, the SNC 108 may pair a mobile device 104 to a local player 124 and an associated output device 120, enabling the mobile device 104 to deliver content to the local player 124, and to have that content output through the output device 120.

A system 100 in accordance with embodiments of the present disclosure can include various other devices and network nodes, located locally or remotely with respect to the output devices 120. For example, a local premises or hotel head end system 130 may be provided that includes the SNC 108 and a local area network switch, router, and/or Internet access core 132, which may be associated with a wireless or wireline (e.g., Ethernet) network or networks. As a further example, a guest Internet access controller (GIA) 136 can be provided as part of the head end system 130 for controlling and authorizing access to the first wireless network 112 by mobile device 104, or other devices. The head end system 130 may generally include a control center in an entertainment system where various signals are brought together and monitored before being introduced into the local entertainment network. Accordingly, the reference to head end system 130 is not limited to video entertainment providers, such as cable tv systems, but may also include various monitoring and control features associated with Internet access, wireless Internet access, output devices 120, local players 124, and other devices and services a guest of a hospitality establishment may use. Various other devices may be connected to the head end system 130 via the Internet 140. Examples of such systems include a local player app and asset server 144, a remote communication interface (RCI) server 148, and an information services provider server 152 residing at location 156. Location 156 may be remote from the head end system 130, within the head end system 130, on the hospitality or hotel premises, or distributed between multiple physical locations—including where all are resident in the headend 130, or distributed amongst several locations 156. In general, the app and asset server 144 may handle communications with an app running on a local player 124. The RCI server 148 may comprise a cloud server that creates pairing codes that are returned in response to a request to initiate a pairing between an output device 120 and a mobile device 104, directly or through a local player 124. The information services provider server 152 may provide information, such as but not limited to, hospitality-related, guest-related, and/or locally-related content to the local player 124 and/or the SNC 108.

In accordance with at least some embodiments of the present disclosure, pairing between a mobile device 104 and an output device 120 is performed in connection with a request for a pairing code that is entered through interaction of a guest or other user with a menu system displayed by the output device 120 that is operated in connection with an on-site host provided as part of the head end system 130. For example, a particular implementation of an SNC 108 or an additional head end server, which is operable to provide on-demand or other programming and interactive television functions via an output device 120, can provide the menu system that enables a user to request a pairing code. When the user selects a menu item in the interactive television system to request a pairing between the mobile device 104 of the user and the output device 120, the head end system 130 makes a request for a pairing code that is created by a web service call to the RCI server 148. The information sent to the RCI server 148 to generate the pairing code may include a site identifier, a guest ID, and/or a TV terminal ID where the code was requested from. The pairing code is returned from the RCI server 148 to the head end system 130, which displays it to the guest via the television (i.e., the output device 120).

The displayed code is then entered by the guest into a connectivity app that is running on the mobile device 104 that provides connectivity to the RCI server 148. More particularly, the connectivity app on the user device 104 transmits the code along with the IP/MAC address information needed for association of the mobile device 104 with the output device 120 and the associated local player 124 by the SNC server 108. The mobile device 104 is then registered with the SNC server 108, including an association between the mobile device 104 and the output device 120. Alternatively, or in addition, the SNC server 108 may use the room number and IP/MAC address of the mobile device 104 to create a pairing between the local player 124 in the guest room and the mobile device 104. The pairing is dissolved when the head end system 130 receives a checkout message from the site's property management system (PMS). That is, when the checkout message is received, the head end system 130 may make a web service call to the SNC server 108 to dissolve all device pairings in a room. If a PMS system is not sending messages to the head end system 130, the head end system 130 can operate such that the guest is checked out at a specific time each day, at which time all device pairings for the room may be dissolved.

In accordance with still other embodiments of the present disclosure, pairing can be performed without requiring an interactive television system running through a local head end system 130. Instead, pairing can be performed in connection with an application running on a local player 124 interacting with the RCI server 148.

The app on the local player 124 can be launched via a command from the SNC server 108 when the SNC server 108 detects that a local player 124 has powered up. A local player app or application, such as a default app at power up, makes a web service call to the local SNC server 108 to get information regarding in what room and site it is installed. The information from the local SNC server 108 also contains the URL for what app, such as a second app, to launch. Once this information is retrieved, the local player app calls the specified URL and loads the requested application from a server. The URL for the requested application may point to the application and asset server 144, the information services provider server 152, the SNC 108, and/or another server providing or otherwise serving an app to the local player 124. The app running on the local player 124 then communicates, via a web service call for example, with the RCI server 148 to generate a pairing code. The information sent to the RCI server 148 to generate the pairing code includes a site identifier and room number where the code was requested from. The RCI server 148 generates the pairing code and returns it to the local player app.

The local player app then displays the received pairing code on the output device 120 to the user. The pairing code can be generated on a timed basis, refreshed by an API call, or other criteria. The user then enters the code into the connectivity app running on the mobile device 104. The connectivity app transmits the pairing code entered by the user, along with the IP/MAC address information needed to allow the SNC server 108 to associate the mobile device 104 with the local player 124 to the RCI server 148. The RCI server 148 makes a web service call to the SNC server 108, passing the information from the mobile device 104 to the SNC server 108. The SNC server 108 uses the room number and IP/MAC address of the mobile device 104 to create a pairing between the local player or players 124 in the guest room and their mobile device 104. Optionally, the app running on the local player 124 can continue to display the pairing code after a mobile device 104 has been paired, to enable other devices 104 to be paired to the local player or players 124. In addition, the app running on the local player 124 can provide an indication to the user that pairing has been successfully completed.

A flag can be set in the SNC server 108 to dissolve all pairings at the site at a scheduled time each day. Alternatively, a property management system can make a call to a web service to dissolve a pairing for a particular room at a selected time.

In accordance with other embodiments of the present disclosure, pairings can be completed in association with an app running on a mobile device 104 that is not associated with the head end system 130 or the RCI server 148. That is, a “third-party” app running on the mobile device 104 can be configured to provide necessary information to the RCI server 148 in order to start the device registration and pairing process. The information provided by the app can include a site identifier, room number, guest device Wi-Fi IP, and/or MAC address. The RCI server 148 makes a web service call to the SNC server 108, passing the information from the mobile device 104 to the SNC server 108. The SNC server 108 uses the room number and IP/MAC address of the mobile device 104 to create a pairing between the local player 124 in the guest room and the mobile device 104. Accordingly, the user never has to enter a pairing code. In a typical implementation, the third-party app is an app provided by the hotel offering connectivity to televisions or other output devices 120 in guest rooms. In accordance with at least some embodiments, a user is required to enter items of information, such as room number, hotel rewards program login credentials, or other information. A pairing thus established can be dissolved through a web service call/API. For example, upon check out from the room, the third-party app can pass a site identifier in the room number to the RCI server 148. The RCI server 148 makes a web service call to the site's SNC server 108 passing the room number information. The SNC server 108 uses the room number to cancel all pairing associations between a room and all user devices 104 assigned to that room and previously paired. If the third-party app does not implement the web service call to dissolve pairing, the pairing can be dissolved through a message sent from a property management system, the pairing can be dissolved at a specific time each day, or pairing can be dissolved manually through a command entered by the user.

In accordance with still other embodiments of the present disclosure, pairing can be completed in association with a guest Internet access (GIA) login. In particular, when a user signs on to a hotel's guest Internet access system 136, that system is aware of the user device's 104 IP and MAC addresses. Most GIA systems are also aware of the guest room number for identity validation or property management system integration purposes. At the time of signing in, the GIA system 136 sends site identifier, room number, and guest device Wi-Fi IP and/or MAC address to the RCI server 148, via a web service call/API. The RCI server 148 in turn makes a web service call to the correct site's SNC server 108, passing the information about the guest's device 104 from the GIA server 136 to the SNC server 108. The SNC server 108 uses the room number and IP/MAC address of the user device 104 to create a pairing between the local player 124 in the guest room and the user device 104. In addition to providing convenient pairing of a user device 104 in the form of a smart phone, such embodiments also enable laptop computers, tablets, or other devices that may support casting through the chrome browser or other applications to an output device 120.

A user device 104 association with a room can be provided to the RCI server 148 by the GIA system 136 upon guest checkout or dissolution of a user device's 104 association with a room. The RCI server 148 makes a web service call to the SNC server 108 for the site, passing the room number information. The SNC server 108 uses the room number to cancel all pairing associations between the room and user devices 104 assigned to that room. Alternatively, a checkout message from a PMS, automatic dissolution at a scheduled time each day, manual guest dissolution, or other options for dissolving a pairing can be implemented.

In accordance with still other embodiments, a web service/API to request all devices currently registered for a guest Internet system can be polled when the SNC server 108 detects that a local player 124 is being powered on, to determine if there are any user devices 104 currently assigned to that room. Information regarding such user devices 104 returned by the GIA system 136 can be used by the SNC server 108 to match the user devices 104, by room number, to the appropriate local player or players 124. This polling could be performed periodically, for example where local players 124 are powered on continuously. Pairings can be dissolved when validation checks, for example performed when a local player 124 boots up, determine that a formerly valid user device 104 is no longer associated with the GIA system 136.

In accordance with at least some embodiments of the present disclosure, the SNC server 108 can be configured to point at a defined Web service and broadcast helpful messages to that service. A “casting started” and “casting ended” method may be broadcast when a user starts casting content and when they stop casting. This would allow a third-party provider or system to appropriately tune the television, or set-top box associated with an output device 120. A user can then perform casting through selecting a casting icon in a selected content app. Upon making such a selection, a DRE server or set-top box listening for such events could perform the necessary tuning to the appropriate HDMI input. In such embodiments, information maintained by the SNC server 108 can include a field identifying, for each local player 124, a unique identifier for an associated set-top box or tuner. This information can be passed as part of the broadcast messages. Alternatively, or in addition, a master flag can be set on a per room basis to indicate whether a room is available for casting, locked to a currently paired device 104, or to implement protocols to charge a fee before casting can be initiated.

In accordance with still further embodiments of the present disclosure, the system 100 can implement app blocking. In particular, the system 100 can control or limit the apps that can be run in connection with a pairing between a user device 104 and a local player 124. For example, apps that may be disruptive, such as a local player configuration app or an unspecified Torrent app, can be blocked by refusing to answer a request by a user device 104 to launch those apps. This prevents the user from changing the local player 124 settings, or from running potentially unfriendly apps. In accordance with at least some embodiments, blocking can be implemented by having the SNC 108 block the ability to send web calls to the local player 124 via a specific TCP port on the local player 124 that is used by a configuration app. In addition, or alternatively, white lists, black lists, and the like can be used.

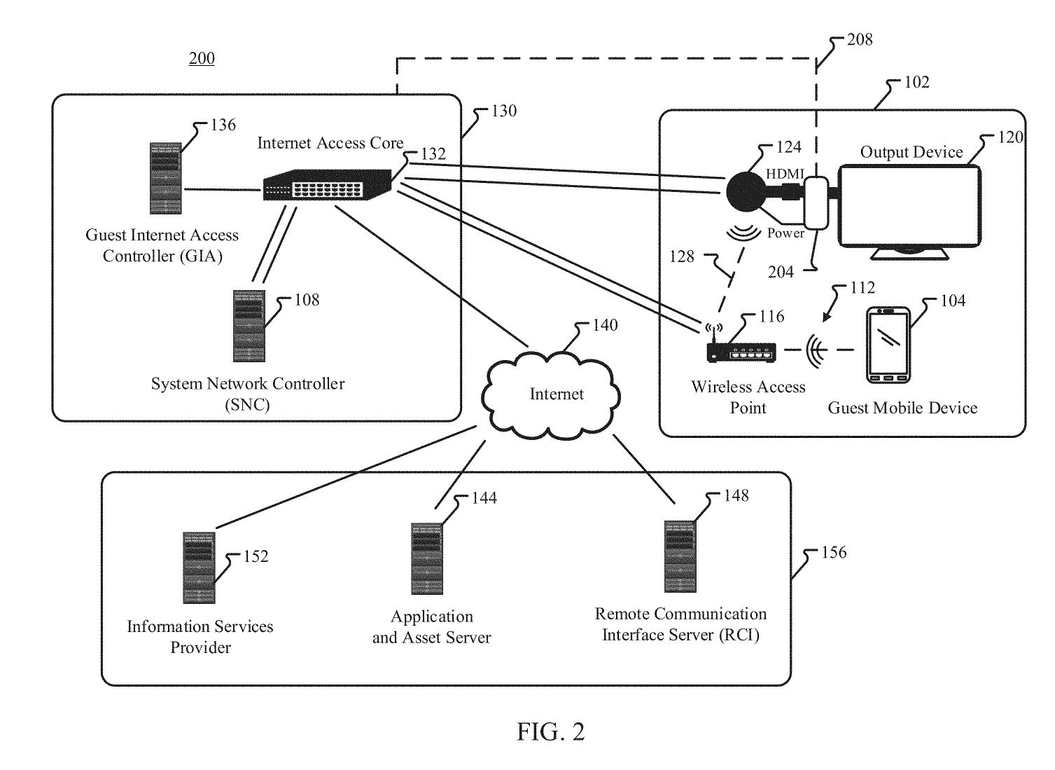

FIG. 2 is a block diagram illustrating an alternate system 200 for enabling connectivity in accordance with embodiments of the present disclosure, and, in particular, a system 200 that enables the user device 104 to selectively connect to an output device 120 through a device 204, such as a set-top box (STB) or other system configured to work with the head end system 130. Accordingly, this system 200 differs from the system 100 illustrated in FIG. 1 in that this system 200 operates in association with a device 204 that may control content displayed to the output device 120 using existing configurations. Therefore, the OTT device, including the local player 124, may be connected to an HDMI port for example, and the device 204 may selectively control the local player 124 to enable/disable content to be displayed at the output device 120. In that the device 204 may already exist and implement or otherwise be part of an already existing configuration/setup, the device 204 may connect with the head end system 130 via a third communication network 208, which may be wireless, Ethernet, coaxial, or other wireline connection.

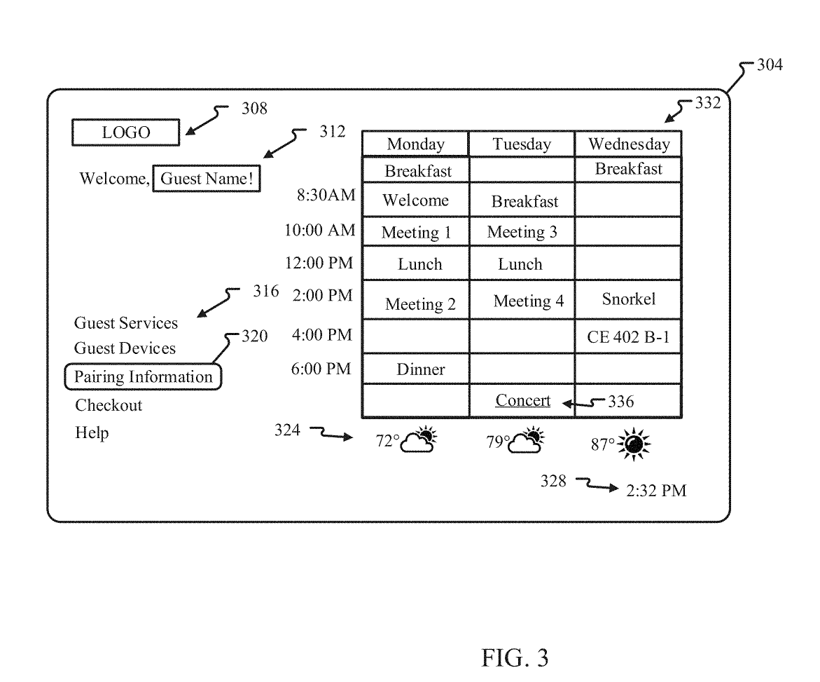

FIG. 3 is an example of a default or welcome display 304 displayed at the output device 120 in accordance with embodiments of the present disclosure. As previously discussed, in instances where the local player 124 is not being used, and/or in instances when the local player 124 is powering on, the welcome screen 304 may be the first, or otherwise give an impression of being the first, content displayed to the output device 120. The welcome screen 304, also referred to as a default display and/or welcome display, may include hospitality branding content 308, such as a logo. The hospitality branding content 308 may be provided from the SNC 108, the information services provider 152, the application and asset server 144, and/or another server accessible to the SNC and/or local player 124. The default or welcome display 304 may include guest information 312, such as a guest name and/or guest schedule 332. The guest information 312 may be provided from the SNC 108, the information services provider 152, the application and asset server 144, and/or another server accessible to the SNC 108 and/or local player 124. The default or welcome display 304 may include an interactive content section 316, which may allow a user to interact with, control, or otherwise participate in the welcome display 304. For example, a guest may move a selection box from a first position to pairing information 320; selecting pairing information 320 may display pairing information associated with the user device 104, and/or the room 102. The guest may use a remote or an app to move the selection box in FIG. 3. Alternatively, or in addition, the entirety of or portions of the interactive content section 316 may not be interactive at all; instead, the interactive content section 316 may display actual pairing information and/or an actual listing of guest devices. The guest information 312 may be provided from the SNC 108, the information services provider 152, the application and asset server 144, and/or another server accessible to the SNC 108 and/or local player 124.

The default or welcome display 304 may include local information 324 that is local to the hospitality services provider. For example, the local information 324 may include, but is not limited to, weather information. The local information 324 may be provided from the SNC 108, the information services provider 152, the application and asset server 144, and/or another server accessible to the SNC 108 and/or local player 124. As previously discussed, the guest information may include a guest schedule 332 and the guest schedule 332 may include information provided from the SNC 108, the information services provider 152, the application and asset server 144, and/or another server accessible to the SNC and/or local player 124. The guest schedule 332 may additionally include information obtained from or provided by the user device 104. For example, the user device 104 may grant access to the information services provider server 152 for example. Calendar events, contacts, and other information may then be requested by the local player 124 via a web services call such that the local play 124 can assemble and then display such information at the output device 120. In some instances, the schedule 332 may include links, such as a link 336 that provides additional information associated with one or more information content pieces within the schedule 332. Importantly, the default or welcome display 304 is launched and displayed on the output device 120 with no guest interaction. That is, when the local player 124 is not in use and/or when the local player 124 is powered on, the default or welcome display 304 is displayed at the output device 120.

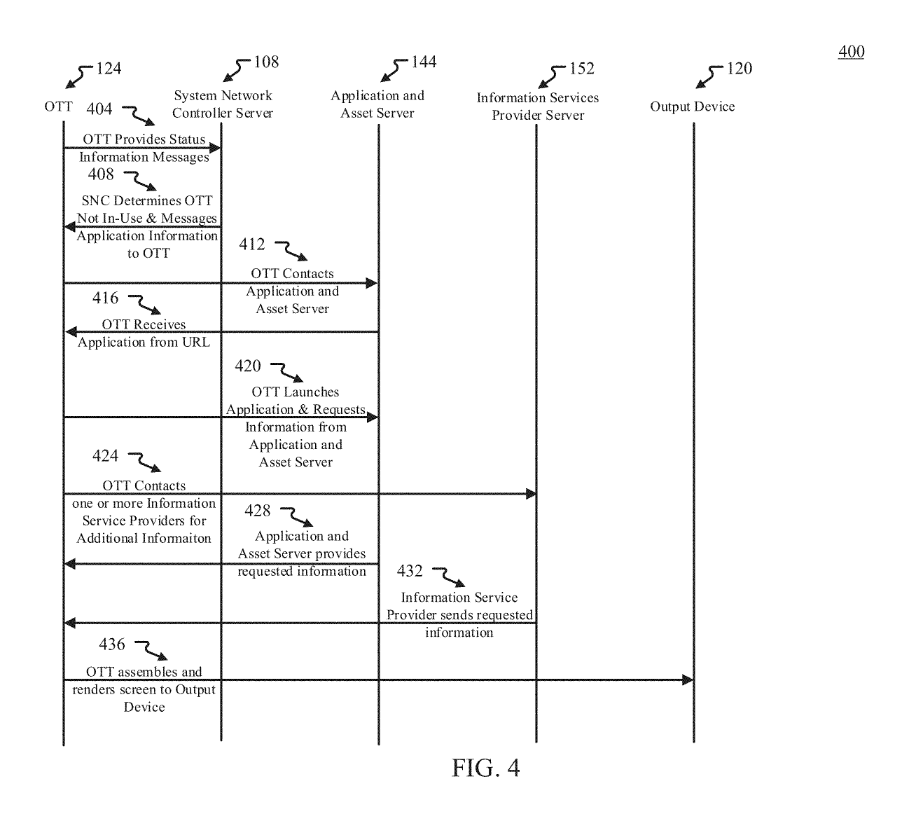

FIG. 4 depicts aspects of the operation of a system for selecting and delivering default content, such as a default or welcome screen 304 in accordance with embodiments of the present disclosure. That is, FIG. 4 generally illustrates a messaging flow diagram. Initially, at step 404, the OTT/local player 124 provides status information to the SNC server 108 using a status information message for example. Such status information message may include information related to the OTT/local player 124 having not been in use for a predetermined period of time, or a measurement of time that the OTT/local player 124 has not been in use. Alternatively, or in addition, the status information message may include information indicating that the OTT/local player 124 has just powered on. The SNC 108 then determines that the OTT/local player 124 has not been in use or has been powered on at step 408 and as a result, sends the OTT/local player 124 an application ID related to the default or welcome display 304 that the OTT/local player 124 is to run. Accordingly, at step 412, the OTT/local player 124 contacts the application and asset server 144 and provides the application ID. The application and asset server 144 may then provide a Uniform Resource Locator (URL) to the OTT/local player 124 at step 416. After launching the application associated with the URL, at step 420, the OTT/local player 124 may request information from the application and asset server 144. The information requested may pertain to hospitality branding information, such as the logo 308. Alternatively, or in addition, the OTT/local player 124 may contact the information services provider server to obtain guest information such as name 312, schedule 332, and local information 324 at step 424. Alternatively, or in addition, the OTT/local player 124 may contact the SNC 108 and retrieve pairing information and/or other device information. Such contacts by the OTT/local player 124 to the application and asset server 144, the information services provider server 152, and the SNC 108 may be made by a web services connection.

The OTT/local player 124 may then receive such information from the application and asset server 144, the information services provider server 152, and/or the SNC 108 at steps 428 and 432 and assemble and render the resulting default or welcome display to the output device 120 at step 436. Noticeably absent from the flow messaging diagram of FIG. 4, is any interaction from the user. That is, the default or welcome display 304 is provided to the output device with no user interaction. Rather, the SNC 108 essentially tells the OTT/local player 124 which application to launch, such as the application presenting the welcome screen 304.

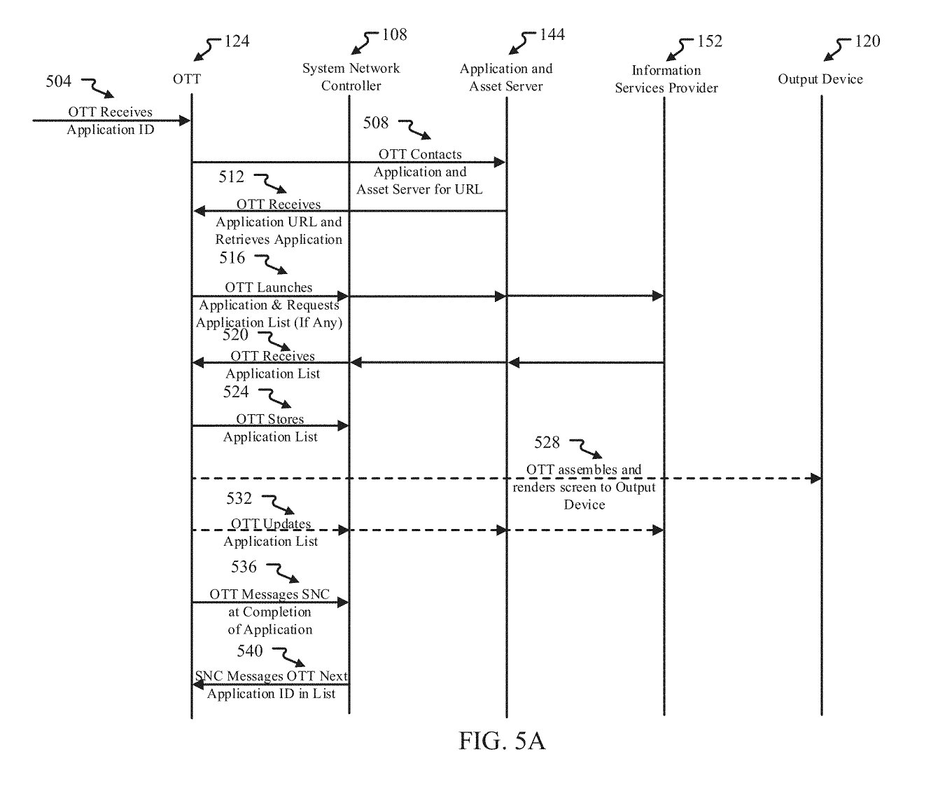

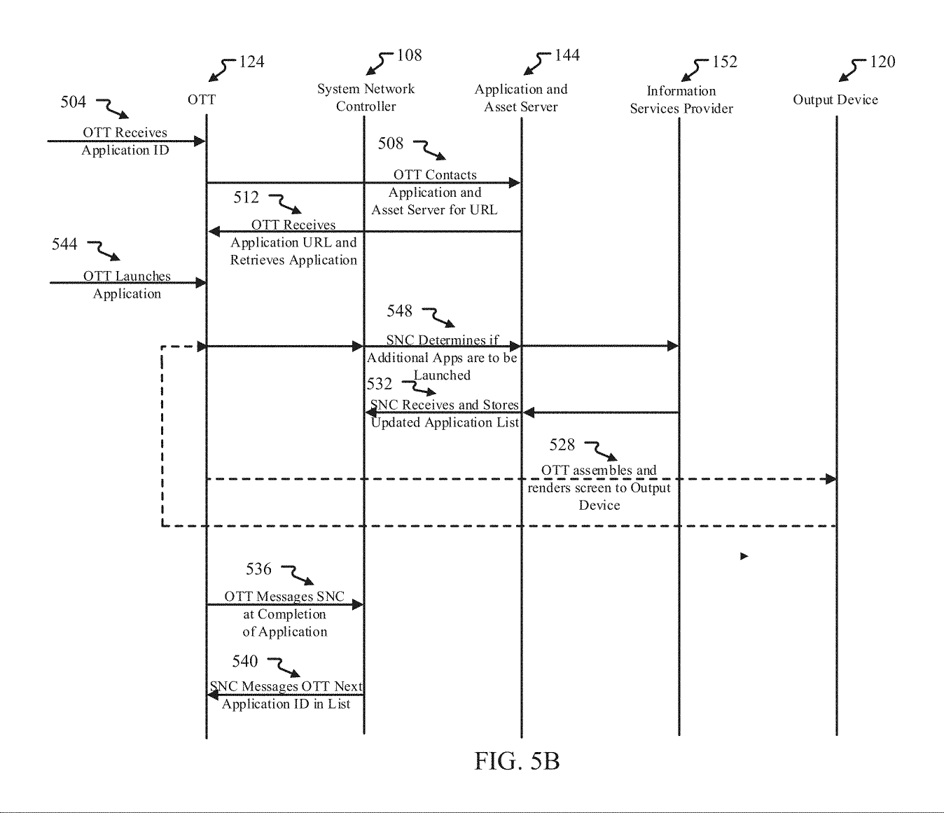

FIG. 5A depicts aspects of the operation of a system for initiating a controlling application chaining of selected apps or applications in accordance with embodiments of the present disclosure. That is, FIG. 5A generally illustrates a messaging flow diagram. Initially, at step 504, an application identifier is received at the OTT/local player 124; the application identifier may identify an application that is to be initially launched. The application identifier may be received from a user device 104, the SNC 108, and/or another server in communication with the OTT/local player 124. The OTT/local player 124 may then contact the application and asset server 144 at step 508 to receive the Uniform Resource Locator (URL) associated with the received application ID. In some instances, the OTT/local player 124 may contact an intermediate server or service to obtain an address of the application and asset server 144 based on the application ID. At step 512, the OTT/local player 124 receives the application URL and launches the application at step 516. Further, at step 516, the app may contact one or more of the SNC 108, the application and asset server 144, and/or the information services provider 152 and request a list of applications to be launched. Such contact may be in the form of a web services call. The list of applications may be in the form of application identifiers and/or URLs.

At step 520, the OTT/local player 124 receives the application list and then stores the application list at step 524. The application list may be stored locally at the OTT/local player 124, at the SNC 108 as depicted in FIG. 5A, or at another accessible location. At step 528, the OTT/local player 124 may assemble and render content to be displayed at the output device 120 while executing and/or launching the application. Further, based on the launching and execution of the application associated with the application identifier, an updated application list may be needed. For instance, if a portion of the application is executed based on one or more conditions that indicate another app should be launched and/or executed, the application list may be updated to include such app, at step 532 for example. Likewise, if a portion of the application is executed based on one or more conditions that indicate an application in the current list should not be launched and/or executed the application list may be updated to exclude such app. Moreover, in that the application list may be stored locally at the OTT/local player 124, at the SNC 108, at the application and asset server 144, and/or at the information services provider 152, OTT may utilize a web services call to update such list. At step 536, and at the completion of the currently running app, the OTT/local player 124 may message the SNC 108 to indicate that the current app has completed and the next app in the list should be executed. Accordingly, at step 540, the SNC 108 may message the OTT/local player 124 with the next application identifier in the application list. Thus, the process may repeat at step 504 until all applications in the list have been executed and/or have completed execution.

FIG. 5B depicts aspects of the operation of a system for initiating a controlling application chaining of selected apps or applications in accordance with embodiments of the present disclosure. That is, FIG. 5B generally illustrates a messaging flow diagram. FIG. 5B differs from FIG. 5A in that the SNC 108 maintains an application list and causes the OTT/local player 124 to launch the applications in the list. That is, at step 504, an application identifier is received at the OTT/local player 124; the application identifier may identify an application that is to be initially launched. The application identifier may be received from a user device 104, the SNC 108, and/or another server in communication with the OTT/local player 124. The OTT/local player 124 may then contact the application and asset server 144 at step 508 to receive the Uniform Resource Locator (URL) associated with the received application ID. In some instances, the OTT/local player 124 may contact an intermediate server or service to obtain an address of the application and asset server 144 based on the application ID. At step 512, the OTT/local player 124 receives the application URL and launches the application at step 544. At step 548, the SNC 108 determines if there are additional applications to be launched. This determination may be based on the currently running application, and/or information from the application and asset server 144 and/or the information services provider server 152 indicating that one or more apps should be launched. Alternatively, or in addition, the SNC 108 may determine that another app should be launched at the conclusion of the existing app. Accordingly, at step 532, the SNC 108 may receive an application list and then store or otherwise update an existing application list located at the SNC 108.

At step 528, the OTT/local player 124 may assemble and render content to be displayed at the output device 120 while executing and/or launching the application. Further, based on the launching and execution of the application associated with the application identifier, an updated application list may be needed. For instance, if a portion of the application is executed based on one or more conditions that indicate another app should be launched and/or executed, the application list may be updated to include such app. Likewise, if a portion of the application is executed based on one or more conditions that indicate an application in the current list should not be launched and/or executed the application list may be updated to exclude such app. Accordingly, steps 548 and 532 may be performed multiple times.

At step 536, and at the completion of the currently running app, the OTT/local player 124 may message the SNC 108 to indicate that the current app has completed and the next app in the list should be executed. Accordingly, at step 540, the SNC 108 may message the OTT/local player 124 with the next application identifier in the application list. Thus, the process may repeat at step 504 until all applications in the list have been executed and/or have completed execution.

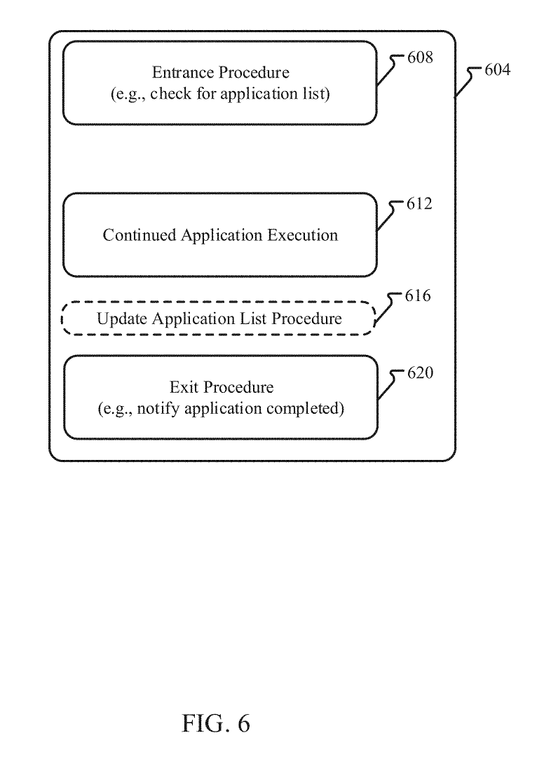

FIG. 6 depicts one or more components of an app, or application, 604 to be launched at the OTT/local player 124 in accordance with embodiments of the present disclosure. In instances where multiple apps are desired to be launched in a serial order, also referred to herein as application chaining, and where each app may include components, modules, and/or programming code to execute such app chaining, the app 604 may include an entrance procedure 608 and an exit procedure 620. The entrance procedure 608 may determine how the app 604 is to behave when initially launched. For example, the app 604 may message the SNC 108 at launch to inform the SNC 108 that it is launching an application; the application identifier may be included in such a message. Further, the entrance procedure 608 may require that the app 604 check with one or more sources of information, for example the SNC 108, the application and asset server 144, and/or the information services provider server 152 to determine if an application list already exists or needs to be created. Such contact may be in the form of a web services call for example. In some instances, the application list may exist on a device other than the OTT/local player 124. For example, the application list may be maintained at the SNC 108, the application and asset server 144, and/or the information services provider server 152.

The component 612 may be the programing instructions which execute the functionality of the app 604. In some instances, the app 616 may include instructions to update the previously mentioned application list based on one or more conditions encountered when executing the app 604. For example, if, based on a determination that a user wished to launch an application associated with a checkout procedure, the application list may be updated to execute an app directed to guest feedback and comments. Moreover, such app may be different depending on a length of stay, a frequency of stay, and/or certain services utilized by said guest. Component 620 may be an exit procedure. Similar to the entrance procedure 608, the OTT/local player 124 may communicate with one or more sources of information, for example the SNC 108, the application and asset server 144, and/or the information services provider server 152 to indicate that the app 604 has finished execution. Accordingly, if another app is to be executed without user interaction, at least one of the SNC 108, the application and asset server 144, and/or the information services provider server 152 may provide the next app in the application list, via an application identifier, to the OTT/local player 124 to execute such app.

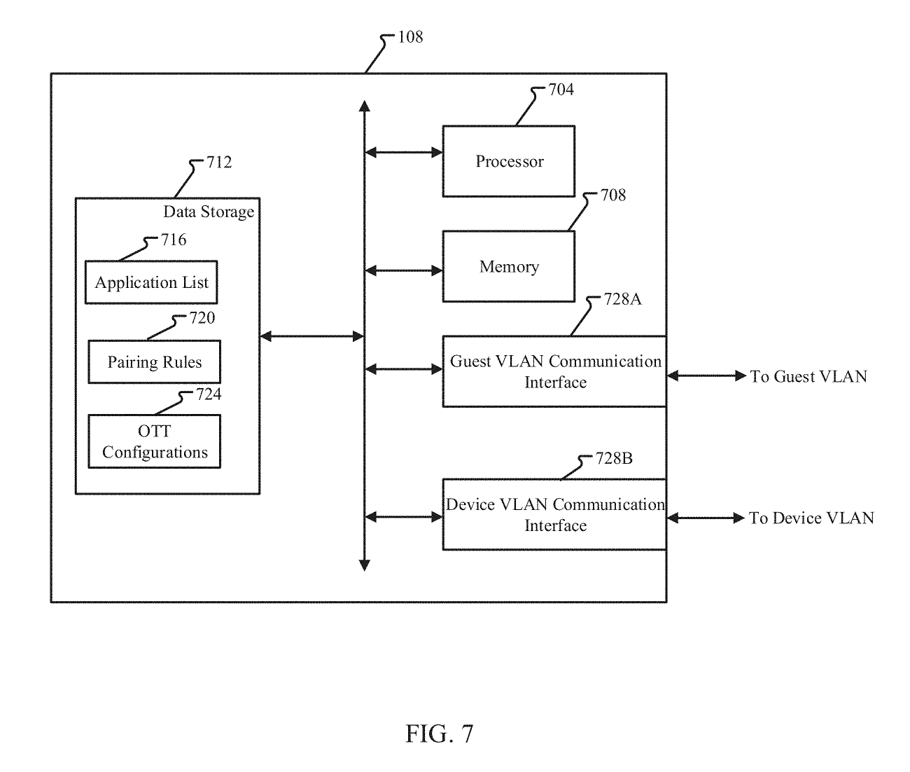

FIG. 7 is a block diagram illustrating components of a system network controller (SNC) 108 in accordance with embodiments of the present disclosure. In general, the SNC controller 108 includes a processor 704 and memory 708. The processor 704 may comprise a general purpose programmable processor or controller for executing application programming or instructions. As a further example, the processor 704 may comprise a specially configured application specific integrated circuit (ASIC). The processor 704 generally functions to run programming code or instructions, such as applications or programs, implementing various functions of the SNC 108. The memory 708 is generally used in connection with the execution of application programming by the processor 704 and for the temporary or long-term storage of program instructions and/or data. As examples, the memory 708 may comprise removable secure digital storage, RAM, SDRAM, or other solid-state memory.

The SNC 108 can also include data storage 712. In accordance with embodiments of the present invention, data storage 712 can contain program code or instructions implementing various applications or functions executed by the SNC server 108. Like the memory 708, the data storage 712 can comprise a solid-state memory device. In addition, in certain applications, the data storage 712 can be integrated with and/or indistinguishable from the memory 708. Alternatively, or in addition, the data storage 712 may comprise a hard disk drive or other random access memory and/or can be interconnected to the communication server 112, for example as network-attached storage. Programming or modules stored in the data storage 712 and executed by the processor 704 can include, as examples and without limitation, various pairing rules 720, various OTT/local player configurations 724, and/or one or more application lists 716. For example, the OTT/local player configurations 724 may include mapping information associating one or more OTT/local players 124 to one or more specific apps or URLs, such as the welcome screen 304.

The SNC server 108 may also include one or more communication interfaces 728A-B. For example, a first communication interface 728A can provide a connection to the first communication network 116 or guest virtual local area network (VLAN); a second communication interface 728B can provide a connection to a device network, such as the second communication network 128 or the device VLAN.

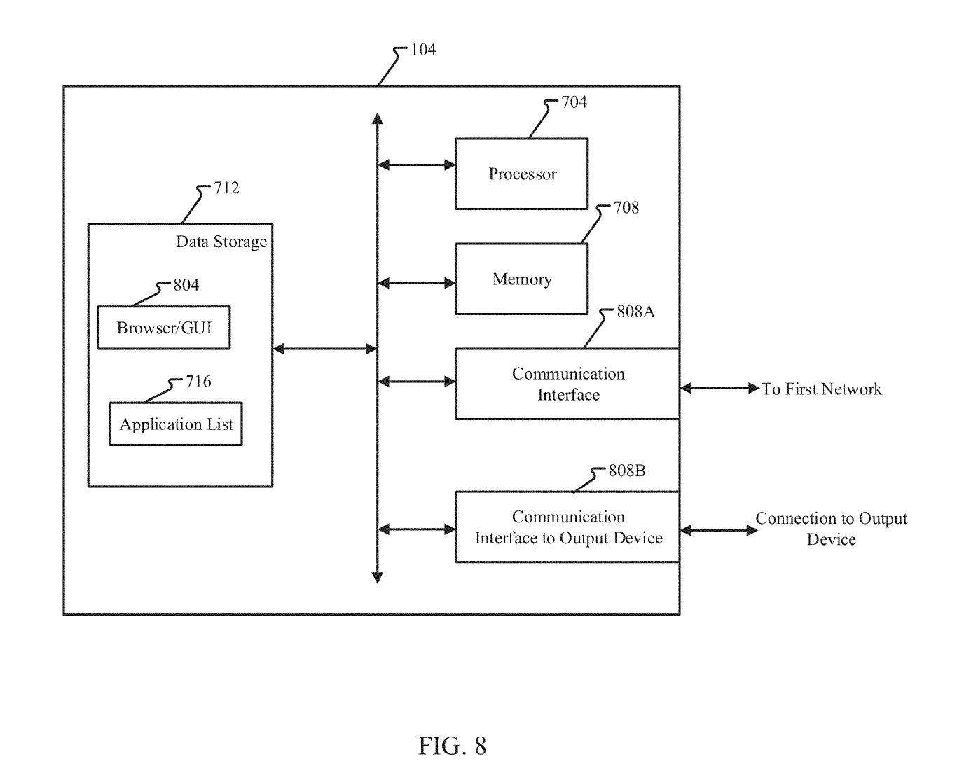

FIG. 8 is a block diagram illustrating components of the OTT/local player 124 in accordance with embodiments of the present disclosure. Like the SNC server 108, the OTT/local player 124 can include a processor 704, memory 708, and/or data storage 712. Program code or instructions that can be stored in data storage 712 and executed by the processor 704 in connection with the memory 708, which can include, but is not limited to, a browser/graphical user interface (GUI) 804 and a locally stored application list 716. In addition, the OTT/local player 124 may include one or more communication interfaces, such as a communication interface 808A connecting to a first network and a connection interface 808B, such as HDMI, connecting the OTT/local player 124 to the output device 120.

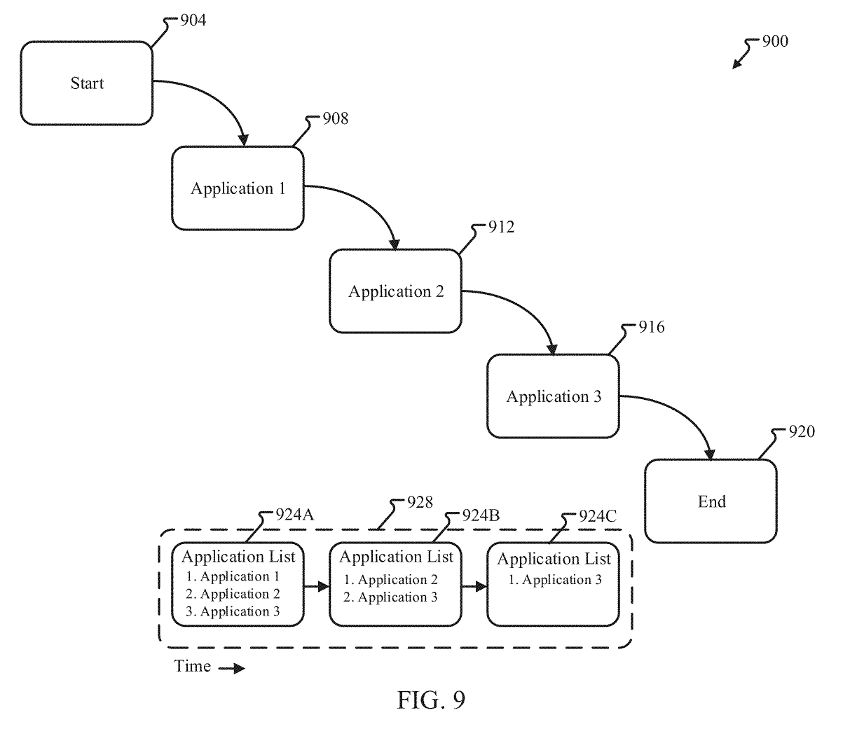

FIG. 9 depicts an application chain 900 in accordance with embodiments of the present disclosure. As depicted in FIG. 9, a first application 908 may be initiated by a starting step 904. In some embodiments, the first application 908 may be launched at the direction of the SNC 108. Alternatively, or in addition, the first application 908 may be launched at the direction of the user device 104. As further depicted in FIG. 9, the second application 912 may be chained or otherwise launched after the first application 908 has been launched. In some embodiments, the second application 912 may be chained or otherwise launched after the first application 908 has completed execution. In some embodiments, the second application 912 and the first application 908 may run in parallel. In some embodiments, the second application 912 and the first application 908 may be run in series. After the second application 912 has been launched, a third application 916 may be launched. That is, the third application 916 may be chained or otherwise launched after the second application 912 has been launched. In some embodiments, the third application 916 may be chained or otherwise launched after the second application 912 has completed execution. Of course, the second application 912 and the third application 916 may be executed in parallel or in series. The application chain may then end at 920.

As further depicted in FIG. 9, changes to an application list 924 are illustrated over time. That is, at a first time, the application list 924A may include the first, second, and third applications. At a second time, the application list 924B may include the second and third application since the first application has completed execution. At a third time, the application list 924C may include the third application since the first and second applications have completed execution. Each of the application lists 924A-924C may be stored in a memory 928, which may be the same as or similar to the memory 708.

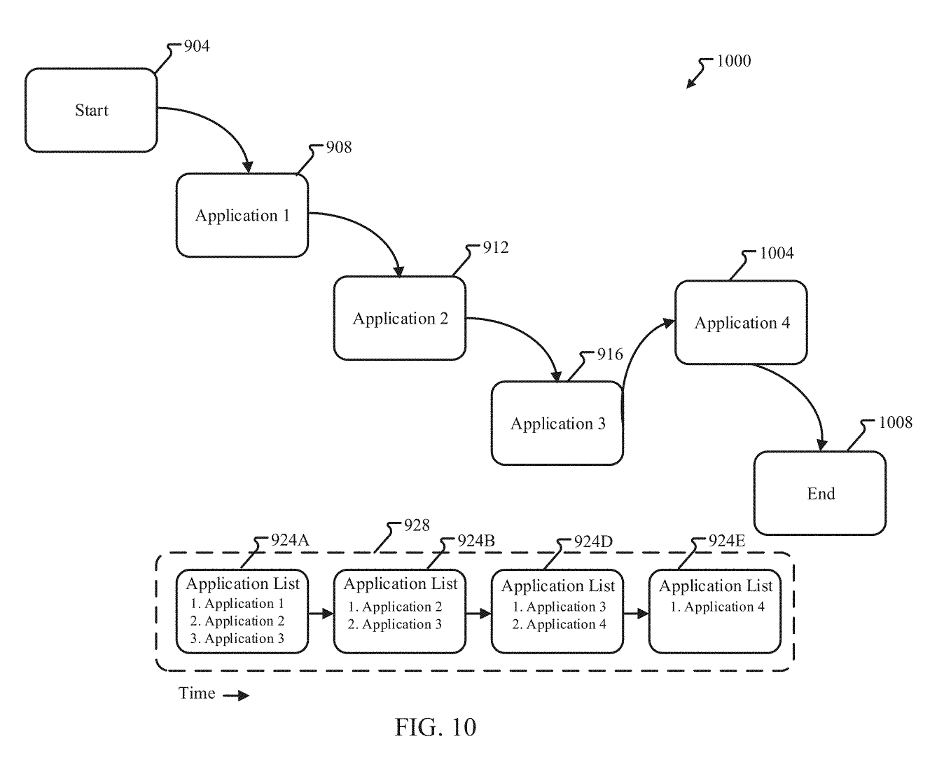

FIG. 10 depicts an application chain 1000 in accordance with embodiments of the present disclosure. As depicted in FIG. 10, a first application 908 may be initiated by a starting step 904. In some embodiments, the first application 908 may be launched at the direction of the SNC 108. Alternatively, or in addition, the first application 908 may be launched at the direction of the user device 104. As further depicted in FIG. 10, the second application 912 may be chained or otherwise launched after the first application 908 has been launched. In some embodiments, the second application 912 may be chained or otherwise launched after the first application 908 has completed execution. In some embodiments, the second application 912 and the first application 908 may run in parallel. In some embodiments, the second application 912 and the first application 908 may be run in series. After the second application 912 has been launched, a third application 916 may be launched. That is, the third application 916 may be chained or otherwise launched after the second application 912 has been launched. In some embodiments, the third application 916 may be chained or otherwise launched after the second application 912 has completed execution. Of course, the second application 912 and the third application 916 may be executed in parallel or in series.

FIG. 10 differs from FIG. 9 in that the execution of the second application 912 for example, may cause the application list 924 to change. That is, the execution of the second application 912 may cause a fourth application 1004 to be added to the application list 924. As further depicted in FIG. 10, after the second application 912 has been launched, the application list 924D includes the third and fourth applications. Accordingly, the fourth application 1004 may be chained or otherwise launched after the third application 916 has been launched. The application chain may then end at 1008.

As further depicted in FIG. 10, changes to the application list 924 are illustrated over time. That is, at a first time, the application list 924A may include the first, second, and third applications. At a second time, the application list 924B may include the second and third application since the first application has completed execution. At a third time, the application list 924D may include the third application 916 and the fourth application 1004 since the fourth application 1004 was added to the application list 924. At a fourth time, the application list 924E may include the fourth application. Each of the application lists 924A-924B and 924D-924E may be stored in a memory 928, which may be the same as or similar to the memory 708.

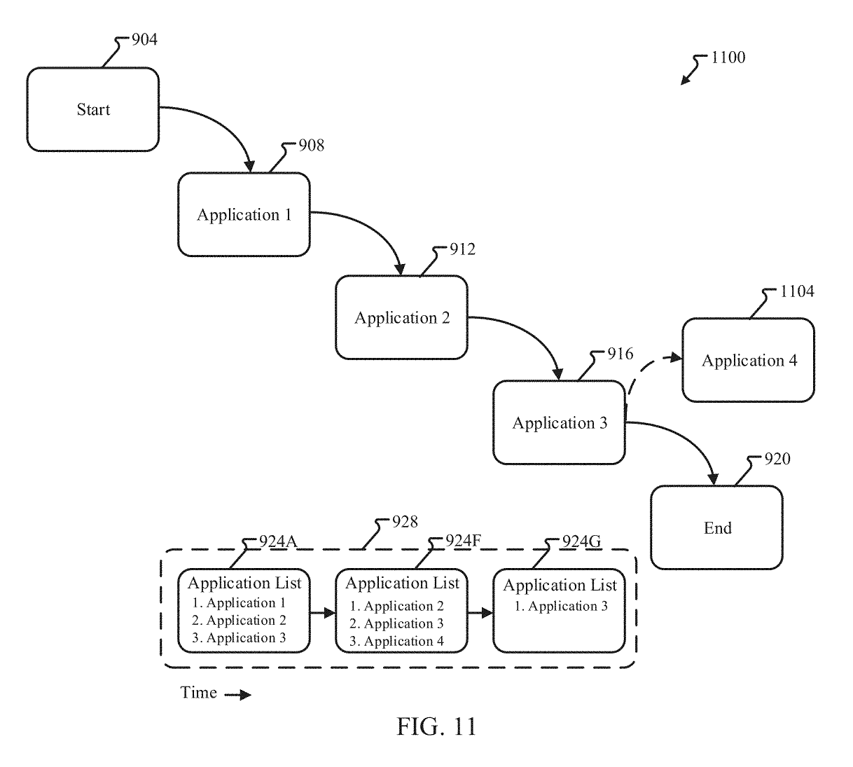

FIG. 11 depicts an application chain 1100 in accordance with embodiments of the present disclosure. As depicted in FIG. 11, a first application 908 may be initiated by a starting step 904. In some embodiments, the first application 908 may be launched at the direction of the SNC 108. Alternatively, or in addition, the first application 908 may be launched at the direction of the user device 104. As further depicted in FIG. 11, the second application 912 may be chained or otherwise launched after the first application 908 has been launched. In some embodiments, the second application 912 may be chained or otherwise launched after the first application 908 has completed execution. In some embodiments, the second application 912 and the first application 908 may run in parallel. In some embodiments, the second application 912 and the first application 908 may be run in series. The second application 912 may add a fourth application 1104 to the application list 924F. After the second application 912 has been launched, a third application 916 may be launched. That is, the third application 916 may be chained or otherwise launched after the second application 912 has been launched. In some embodiments, the third application 916 may be chained or otherwise launched after the second application 912 has completed execution. Of course, the second application 912 and the third application 916 may be executed in parallel or in series.

FIG. 11 differs from FIG. 9 and FIG. 10 in that the execution of the third application 916 for example, may cause the application list 924 to change. That is, the execution of the first application 908 may cause a fourth application 1104 to be added to the application list 924F. The second application 916 may cause the fourth application 1104 to be removed from the application list 924G.

As further depicted in FIG. 11, changes to the application list 924 are illustrated over time. That is, at a first time, the application list 924A may include the first, second, and third applications. At a second time, the application list 924F may include the second, third, and fourth applications since the first application added the fourth application 1104 to the application list 924F. At a third time, the application list 924G may include the third application 916 since the fourth application 1104 was removed from the application list 924G after the launch of the second application 912. Each of the application lists 924A and 924F-924G may be stored in a memory 928, which may be the same as or similar to the memory 708.

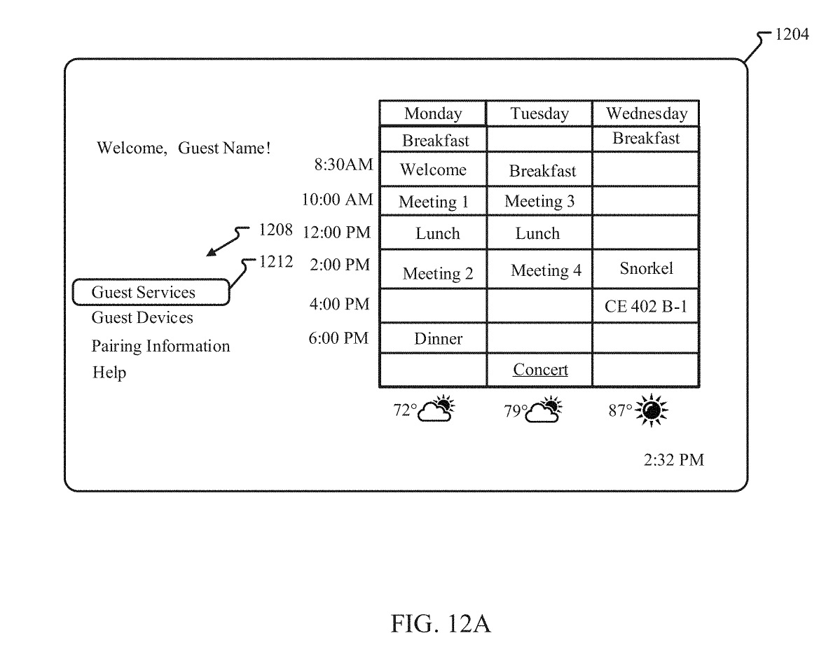

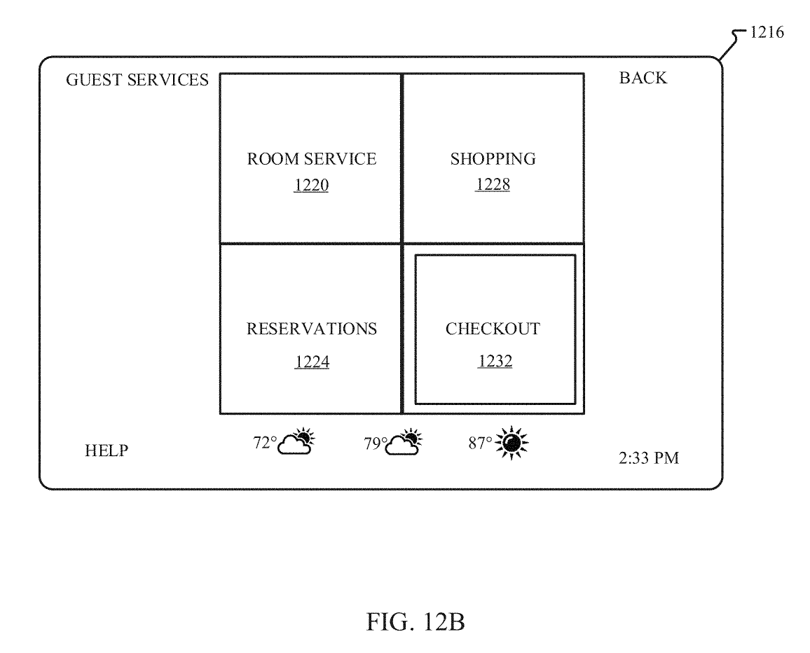

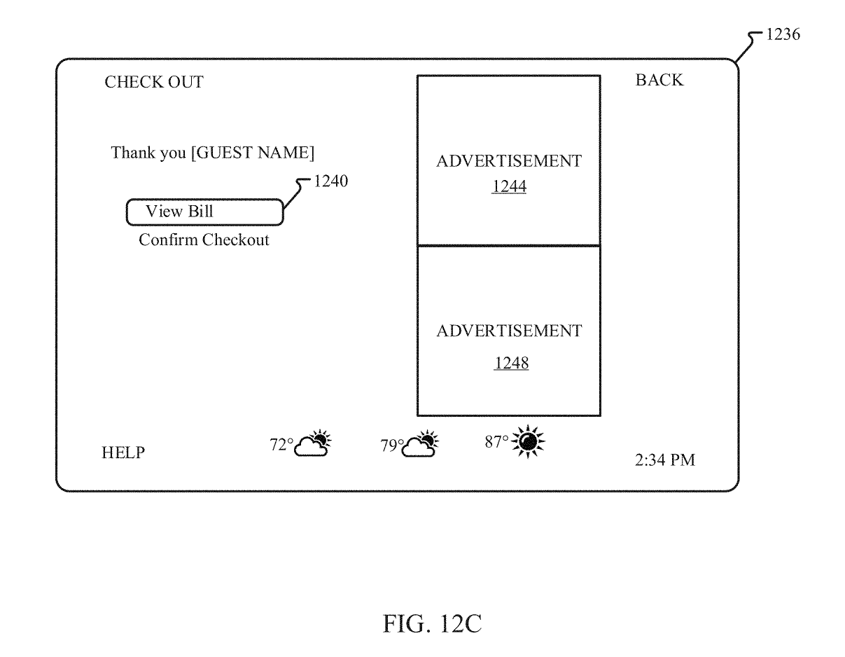

As depicted in FIGS. 12A-12C, a series of displays may be presented to the output device 120 in response to user interaction with the local player 124. That is, as a user navigates and interacts with a display presented to the output device 120, a series of one or more applications may be passively maintained in an application list such that an application chain, or chain of applications, is assembled based on one or more selections of the user. As depicted in FIGS. 12A-12C, the displays 1204, 1216, and 1236 may correspond to different applications executed and running on the local player 124. As initially depicted in FIG. 12A, a user may be presented with an interactive display 1204 as part of a welcome screen, for example. A user, using an in-room remote control, a mobile device 104, and/or a laptop for example, may navigate through a selectable list of menu choices 1208. If the user selects a particular menu choice, for example, guest services 1212, the application displaying the display 1204 may be added to an application list 924 and a new application may be initiated by the SNC 108, for example, and executed by the local player 124. A new application may be initiated, executed, and a different display, such as display 1216, may be provided to the output device 120 and thus the user. In accordance with some embodiments, and as previously discussed, one or more entrance and exit procedures may be performed. For example, when entering the application responsible for display 1216, the application identifier for the application responsible for display 1204 may be provided to the SNC 108 during an exit procedure and an application identifier for the application responsible for display 1216 may be provided to the SNC 108 during an entrance procedure. The display 1216 may include one or more selectable tiles 1220-1232 of which the user may select.

Further still, if the user selects a tile 1220-1232, for example 1232, the application responsible for display 1216 may exit and the application responsible for display 1236 may be entered/initiated. For example, the application responsible for displaying the display 1216 may be added to an application list 924 and a new application may be initiated by the SNC 108 for example, and executed by the local player 124. As an example, a new application may be initiated, executed, and a different display, such as display 1236, may be provided to the output device 120 and thus the user. One or more entrance and exit procedures may be performed; for example, when entering the application responsible for display 1236, the application identifier for the application responsible for display 1216 may be provided to the SNC 108 in an exit procedure and an application identifier for the application responsible for display 1236 may be provided to the SNC 108 in an entrance procedure. As further depicted in FIG. 12C, the user may select another menu choice such as the “View Bill” 1240 menu choice; such menu choice selection may launch another application as previously discussed. One or more advertisements 1244-1248, which may or may not be hyperlinked and selectable, may be displayed in the display 1236. Further, an application, such as a survey application, may be added to an application list during an entrance and/or exit procedure.

Accordingly, the present invention has been described with some degree of particularity directed to the exemplary embodiments of the present invention. It should be appreciated though that modifications or changes may be made to the exemplary embodiments of the present invention without departing from the inventive concepts contained herein.

What is claimed is:

1. A communication system in a hospitality environment, the communication system comprising:
a server;
an output device, and
a local player in communication with the server and configured to provide display information to the output device, wherein the local player is configured to provide a status message to the server, receive application identification information from the server identifying one or more applications to execute, retrieve additional content from a content source, and execute the one or more applications thereby providing the display information including the additional content to the output device for display at the output device.

2. The communication system of claim 1, wherein the status message indicates that the local player is in an inactive state.

3. The communication system of claim 1, wherein the status message indicates an amount of time that the local player has been inactive.

4. The communication system of claim 3, wherein the additional content is guest-related information including at least one guest name.

5. The communication system of claim 4, further comprising:
a first network connecting the server to the local player; and
a second network connecting the local player to the content source.

6. The communication system of claim 5, wherein the content source is physically located at a site other than a site at which the local player is physically located.

7. The communication system of claim 4, wherein the additional content includes location information related to a location in which the local player is located.

8. A method for displaying content at an output device, the method comprising:
providing, by a local player connected to the output device, a status message to a system network controller indicating that the local player is inactive;
receiving, at the local player, application identification information, the application identification information identifying one or more applications to launch;
retrieving additional content from a content source;
assembling display information that includes the additional content received from the content source; and
providing the assembled display information to the output device.

9. The method of claim 8, wherein the status message indicates that the local player is in an inactive state.

10. The method of claim 8, wherein the status message indicates an amount of time that the local player has been inactive.

11. The method of claim 8, wherein the additional content is guest-related information including at least one guest name.

12. The method of claim 11, further comprising retrieving location information related to a location in which the local player is located, wherein the assembled display information includes the guest-related information and the location information.

13. A method for chaining two or more applications together, the method comprising:
receiving, at a local player, first application identification information, the first application identification information identifying a first application to launch;
launching the first application;
after launching the first application, determining that a second application is to be launched;
receiving, at the local player, second application identification information, the second application identification information identifying the second application to launch; and
launching the second application.

14. The method of claim 13, further comprising adding the second application identification information to an application list.

15. The method of claim 14, further comprising removing third application identification information identifying a third application from the application list.

16. The method of claim 14, wherein the application list includes application identification information for a plurality of applications.

17. The method of claim 14, wherein the application list is received from a system network controller.

18. The method of claim 14, wherein the second application identification information is added to the application list at a device other than the local player.

19. The method of claim 13, further comprising determining that the second application is to be launched prior to the first application completing execution.

20. The method of claim 19, further comprising providing a notification to a device other than the local player that first application has completed execution.
